(19) United States
(12) Patent Application Publication
(10) Pub. No.: US 2008/0179243 A1
(43) Pub. Date: Jul. 31, 2008

(54) Stationary Phase Gradient Chromatography

(76) Inventors: Allen Hirsh, Silver Spring, MD (US); Latchezar Tsonev, Sofia (BG)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/971,104

(22) Filed: Jan. 8, 2008

Related U.S. Application Data
(60) Provisional application No. 60/879,017, filed on Jan. 8, 2007.

(51) Int. Cl. B01D 15/08

(52) U.S. Cl. 210/635; 210/198.2

(57) ABSTRACT

The present invention is directed to chromatographic media comprising a chromatographic absorbent as a stationary phase, wherein the chromatographic absorbent is disposed in the chromatographic media so as to provide a gradient of hydrophilic, hydrophobic, and/or ionic groups.

### CROSS-REFERENCE TO RELATED APPLICATIONS

This application claims priority to U.S. Provisional Application No. 60/879,017, filed Jan. 8, 2007, which is herein incorporated by reference in its entirety for all purposes.

### BACKGROUND OF THE INVENTION

Historically, gradient based liquid phase chromatography has played a seminal role in molecular separation science. Originally limited to aqueous ion exchange chromatography, in recent years it has blossomed into numerous useful variations based on hydrophobic interactions and combinations of hydrophobic and hydrophilic interactions including a wide range of mobile and stationary phase chemistries. Despite this wide range of compositions, a universal feature of the current gradient technologies is a focusing of each band of eluted molecules because of increased binding to the stationary phase downstream and decreased binding upstream. This results in a velocity gradient in the eluted species that acts to counter the dispersive forces that would otherwise broaden the elution bands as they travel through the stationary phase. Concentrating eluted material into narrower bands is highly desirable because it leads to better separation of forms that elute at nearly the same conditions, a property known as selectivity, as well as providing a more homogeneous purified product. However, aside from the dispersive forces themselves, there is an intrinsic limitation to the focusing strength of these systems as relates to the challenge of selectivity. Generally, to achieve greater selectivity the gradient in eluent composition should be reduced. This increases the number of stationary phase volumes (or time) between an elution band and its nearest neighbors. Nevertheless, it also decreases the focusing strength of differential binding, so the peaks become broader as a function of stationary phase volumes. Since optimum selectivity is characterized by a maximum ratio of band separation to band width, called resolution, the tradeoff of flattening the gradients always leads to an optimal minimum slope.

### BRIEF SUMMARY OF THE INVENTION

The present invention is a radical restructuring of the focusing forces designed to greatly increase resolution by uncoupling the reciprocal relationship between gradient slope reduction and focusing strength. In the Stationary Phase Gradient Chromatography systems the gradient of binding ability in the stationary phases themselves mean that there will exist increased binding to the stationary phase downstream and decreased binding upstream even during an isocratic elution.

In a preferred embodiment of the invention the eluent composition varies in time so as to maintain one or more gradients in eluent composition over the length of the stationary phase in the direction of flow. Gradient elution greatly increases the probability that all molecular species will actually elute and that resolution can be optimized even in ordinary ion exchange, hydrophobic, and mixed mode separations. However, in Stationary Phase Gradient Chromatography systems, the use of gradients with very small slopes can yield resolution because the difference in the initial elution stationary phase volume (time) between any two bound species becomes greater as the slope decreases, but the focusing strength keeping the peak widths narrow is at least that provided by the stationary phase gradient no matter how small the slope of eluent concentration or pH in the mobile phase.

The present invention also includes a restructuring of the focusing forces in the stationary phase. It is designed to address another of the primary dispersive forces in column chromatography: the decrease in bulk mobile phase velocity as the radial distance to the wall decreases in packed columns, with the maximum distance from the wall defined as the cylindrical axis of rotation perpendicular to the circular bounding faces at each end of the cylinder containing the stationary phase, usually referred to as a column. This is a natural consequence of the laws of fluid flow. The gradient in fluid velocity produces a broadening of the elution peak because molecules that diffuse close to the column wall lag in exiting the column because of the reduced bulk flow near the wall. One way to address this is to decrease the ratio of bound target molecules to free target molecules symmetrically as radial distance from the center of the column increases. This would lead to a compensatory increased time spent in a slower fluid flow for any target molecule, and thus narrower band of elution from the column. In this invention this is achieved by decreasing the binding capacity of the stationary phase, in a radially symmetric fashion, as the radial distance to the boundary wall is decreased. In a preferred embodiment utilizing hydrophobic binding groups on the surface of the stationary phase this is achieved by increasing the ratio of Cₙ groups to Cₘ aliphatic groups as the radial distance to the boundary wall is decreased with n<m; n, m positive integers. In another embodiment, the frequency of stationary phase particles having exclusively Cₘ aliphatic groups on their surface decreases while the frequency of stationary phase particles having exclusively Cₙ aliphatic groups on their surface increases as the radial distance to the boundary wall decreases.

### DETAILED DESCRIPTION OF THE INVENTION

In a preferred embodiment of the invention a chromatographic column is packed in a variation of the usual method of those skilled in the art. An amount of gel matrix slurry consisting of a mixture of n classes of hydrophobic gel particles, n≧1 each class at a predetermined fraction and complementary fractions of m classes of particles, m≧1, each class bearing either cation or anion exchange groups such that the sum of the fractions is one, and the packed volume of the slurry is equal to from 0 to 1 column volumes, is added to a chromatographic column with its outlet closed. Immediately subsequent to this addition the slurry is packed by running several column volumes of an appropriate buffer through the gel at the lowest of the maximum pressures recommended for the classes of particles so as to pack the first layer of column gel. This procedure is repeated with a new slurry mixture of 0 to 1 column volumes, having its own set of n classes of hydrophobic gel particles and m classes of particles each class of the m bearing either cation or anion exchange groups, the fractions of each class either differing from or remaining the same as the fraction of said class in the previous slurry addition to the column, until the column is fully packed. This method creates a distinct gradient in the fraction of each class of gel particle from the inlet of the column to the outlet of the column. For example, one class or type of hydrophobic gel particle can have a surface functionalized or derivatized with covalently bound C₈ aliphatic or hydrocarbon groups, and another class o type of particle can have a surface functionalized with covalently bound C₁₈ aliphatic or hydrocarbon groups.

The hydrophobic gel particles can include particles having hydrophobic groups covalently bound to their surface. Hydrophobic groups can include strongly binding hydrophobic groups, e.g., hydrophobic groups such as C₁₈ hydrocarbons which can have a large number of simultaneous Van der Waals interactions with target molecules. Similarly, weakly binding hydrophobic groups such as C₄ hydrocarbons have few such Van Der Waals interactions with target molecules.

In another preferred embodiment of the invention n classes of gel particles, n≧1, are manufactured. Each class of particle is characterized by having a distinct density of an ionizable anionic or cationic group, e.g. sulfonic, carboxylic, primary amino, secondary amino, or tertiary amino groups, providing electrostatic binding capacity proportional to the density of such groups, covalently linked to the surface of the of the particle, such that the density is not so great as to fill all available surface sites with the ionizable groups. Each class of particle is characterized by having a second distinct density of hydrophobic groups, e.g. aliphatic chains containing k carbons where 2≦k≦18, phenyl chains (e.g., polyphenylene polymers or oligomers) containing I phenyl groups where 1≦I, surfaces derivatized with divinyl benzene, cyano, polyamide, poly(propyl aspartamide), poly(ethyl aspartamide), poly(methyl aspartamide), hydroxyl terminated poly(ethers), polyethers, covalently bound to each particle in that class and occupying all of the remaining surface sites not occupied by the ionizable groups. Subsequently, m lots of gel matrix slurry are created, m≧1, each lot consisting of a mixture of the n classes of hydrophobic gel particles, each class of the n classes at a distinct predetermined fraction with the sum of the n fractions equaling one. A packed volume of the first of the m lots of gel matrix slurry, equal to from 0 to 1 column volumes, is added to a chromatographic column with its outlet closed. Immediately subsequent to this addition the slurry is packed by running several column volumes of an appropriate buffer through the gel at the lowest of the maximum pressures recommended for the classes of particles so as to pack the first layer of column gel. This procedure is repeated for each of the m lots of gel matrix slurry until the column is fully packed. This creates variations in the hydrophobicity and electrostatic strength of the gel matrix as a function of position in the column. Of particular value are gradients in which the hydrophobicity increases or decreases monotonically from the inlet to the outlet of the column, and the density of electrostatic groups changes monotonically concurrently but of the opposite sign, i.e. when hydrophobicity is increasing along the length of the column, electrostatic binding capacity is decreasing along the length of the column and vice versa.

It will be noted that one skilled in the art will recognize that the present invention, and embodiments thereof, can be carried out in any suitable chromatographic media. Chromatographic media include chromatographic columns in which the stationary phase chromatographic absorbent is disposed in solid cylindrical form within the column, or other chromatographic geometries, such as chromatographic sheets (e.g. for thin-film chromatography) in which the stationary phase chromatographic absorbent forms an essentially two-dimensional sheet. Alternatively, the stationary phase chromatographic absorbent can form a hollow cylinder, e.g. on the inside of a tubular support, or on a flexible flat-sheet support rolled up into a tubular form.

The chromatographic media of the present invention, in which the stationary phase chromatographic absorbent forms a gradient of binding ability, can be operated isothermally, or using a temperature gradient. For example, when a chromatographic media comprised a column packed with a stationary phase forming a binding gradient as described herein, the temperature gradient can be longitudinal, such that the temperature varies (e.g. increases or decreases) down the length of the column or varies radially (e.g. increases or decreases in the radial direction) or varies temporally (e.g. changes over time as the separation process progresses). In some embodiments, the temperature varies between about 0° C. to 100° C., inclusive of ranges and subranges there between.

What is claimed:

1. A chromatographic media comprising a stationary phase chromatographic adsorbent, wherein:
the stationary phase chromatographic absorbent comprises strongly binding and weakly binding hydrophobic groups covalently bound to the surface of the stationary phase chromatographic absorbent; and
the stationary phase chromatographic absorbent is disposed in the chromatographic media so that in the direction of flow of an eluent, the stationary phase chromatographic absorbent has:
a surface density gradient of strongly binding hydrophobic groups; and
a concurrent distinct surface density gradient of weakly binding hydrophobic groups,
such that the hydrophobicity of the stationary phase chromatographic absorbent increases substantially linearly or nonlinearly, or decreases substantially linearly or nonlinearly from the entry point of the eluent stream to the exit point of the eluent stream, thereby providing the stationary phase chromatographic absorbent with a time and position varying composition whereby the retention of adsorbed molecules varies with position and time on the stationary phase.

2. The chromatographic media of claim 1, wherein the surface of the stationary phase chromatographic absorbent further comprises covalently bound anionic or cationic groups capable of binding molecules by electrostatic charge interactions.

3. A chromatographic media comprising a stationary phase chromatographic adsorbent, wherein:
the stationary phase chromatographic absorbent comprises a mixture of particles of n types where n≧2;
each of the n types of particle has a different composition of hydrophobic groups covalently bound to its surface, thereby providing each of the n types of particles with a different hydrophobicity; and
wherein the stationary phase chromatographic absorbance is disposed in a chromatographic media so that in the direction of flow of an eluent, the stationary phase chromatographic absorbent the proportions of each of the n types of particles vary so as to create a gradient in overall hydrophobicity such that the hydrophobicity of the stationary phase chromatographic absorbent increases substantially linearly or nonlinearly, or decreases substantially linearly or nonlinearly from the entry point of the eluent stream to the exit point of the eluent stream;
thereby providing the stationary phase chromatographic absorbent with a time and position varying composition whereby the retention of adsorbed molecules varies with position and time on the stationary phase.

4. The chromatographic media of claim 3, wherein the surface of the stationary phase chromatographic absorbent further comprises covalently bound anionic or cationic groups capable of binding molecules by electrostatic charge interactions.

5. A chromatographic media comprising a stationary phase chromatographic adsorbent, wherein the stationary phase chromatographic absorbent comprises covalently bound anionic or cationic groups capable of binding molecules by electrostatic charge interactions on the surface thereof; and
wherein the stationary phase chromatographic absorbent is disposed in the chromatographic media so that in the direction of flow of an eluent, the stationary phase chromatographic absorbent has a density gradient of covalently bound anionic or cationic groups whereby the density of the anionic or cationic groups increases substantially linearly or nonlinearly, or decreases substantially linearly or nonlinearly from the entry point of the eluent stream to the exit point of the eluent stream;
thereby providing the stationary phase chromatographic absorbent with a time and position varying composition whereby the retention of adsorbed molecules varies with position and time on the stationary phase.

6. The chromatographic media of claim 3, wherein the surface of the stationary phase further comprises ion exchange particles which are distinct from the n types of particles;
wherein:
(a) the ion exchange particles have anionic or cationic moieties covalently bound to their surfaces capable of binding molecules by electrostatic charge interactions; and
(b) the proportion of the ion exchange particles relative to the n types of particles increases substantially linearly or nonlinearly from the entry point of the eluent stream to the exit point of the eluent stream.

7. A chromatographic media comprising a stationary phase chromatographic adsorbent, wherein:
the stationary phase chromatographic absorbent comprises covalently bound anionic or cationic groups on the surface thereof, and further comprising covalently immobilized hydrophobic groups capable of binding molecules by hydrophobic interactions; and
wherein the stationary phase chromatographic absorbent is disposed in the chromatographic media so that perpendicular to the direction of flow of an eluent and substantially radially symmetric to the center of flow of the eluent, the stationary phase chromatographic absorbent has a density gradient of covalently bound anionic or cationic groups whereby the density of the anionic or cationic groups increases substantially linearly or nonlinearly, or decreases substantially linearly or nonlinearly from the entry point of the eluent stream to the exit point of the eluent stream;
thereby providing the stationary phase chromatographic absorbent with a time and position varying composition whereby the retention of adsorbed molecules varies with position and time on the stationary phase.

8. A chromatographic media comprising a stationary phase chromatographic absorbent, wherein:
the stationary phase chromatographic absorbent comprises strongly binding and weakly binding hydrophobic groups covalently bound to the surface thereof;
the stationary phase chromatographic absorbent is disposed in the chromatographic media so that substantially perpendicular to the direction of flow of an eluent and substantially radially symmetric to the center of flow of the eluent, the stationary phase chromatographic absorbent has a density gradient of strongly binding hydrophobic groups and a concurrent density gradient of weakly binding hydrophobic groups covalently bound to the surface of the adsorbent whereby the hydrophobicity of the stationary phase chromatographic absorbent decreases substantially linearly or nonlinearly from the center of flow of the eluent stream to the periphery of the flow of the eluent, and substantially radially symmetric to the center of flow of the eluent;
thereby providing the stationary phase chromatographic absorbent with a time and position varying composition whereby the retention of adsorbed molecules varies with position and time on the stationary phase.

9. The chromatographic media of claim 8, wherein the surface of the stationary phase chromatographic absorbent further comprises covalently bound anionic or cationic hydrophilic groups capable of binding molecules by electrostatic charge interactions.

10. A chromatographic media comprising a stationary phase chromatographic adsorbent, wherein:
the stationary phase chromatographic absorbent comprises a mixture of particles of n types where n≧2;
wherein each of the n types of particle has a different composition of hydrophobic groups covalently bound to its surface, thereby providing each of the n types of particles with a different hydrophobicity; and
the stationary phase chromatographic absorbent is disposed in the chromatographic media so that substantially perpendicular to the direction of flow of an eluent and substantially radially symmetric to the center of flow of the eluent, the proportion of each of the n types of particle that comprise the stationary phase vary so as to create a gradient in overall hydrophobicity such that the hydrophobicity of the stationary phase chromatographic absorbent decreases substantially linearly or nonlinearly from the center of flow of the eluent stream to the periphery of the flow of the eluent stream, and substantially radially symmetric to the center of flow of the eluent;
thereby providing the stationary phase chromatographic absorbent with a time and position varying composition whereby the retention of adsorbed molecules varies with position and time on the stationary phase.

11. The chromatographic media of claim 10, wherein the surface of the stationary phase chromatographic absorbent further comprises covalently bound anionic or cationic groups capable of binding molecules by electrostatic charge interactions.

12. A chromatographic media comprising a stationary phase chromatographic adsorbent, wherein:
the stationary phase chromatographic absorbent comprises covalently bound anionic or cationic groups capable of binding molecules by electrostatic charge interactions; and
wherein the stationary phase chromatographic absorbent is disposed in the chromatographic media so that substantially perpendicular to the direction of flow of an eluent and substantially radially symmetric to the center of flow of the eluent, the stationary phase chromatographic absorbent has a density gradient of anionic or cationic groups whereby the density of the anionic or cationic groups increases substantially linearly or nonlinearly, or decreases substantially linearly or nonlinearly from the entry point of the eluent stream to the exit point of the eluent stream;
thereby providing the stationary phase chromatographic absorbent with a time and position varying composition whereby the retention of adsorbed molecules varies with position and time on the stationary phase.

13. A chromatographic media comprising a stationary phase chromatographic adsorbent, wherein:
the stationary phase chromatographic absorbent comprises covalently bound anionic or cationic groups on the surface thereof, and further comprising covalently immobilized hydrophobic groups capable of binding molecules by hydrophobic interactions; and
wherein the stationary phase chromatographic absorbent is disposed in the chromatographic media so that substantially perpendicular to the direction of flow of an eluent and substantially radially symmetric to the center of flow of the eluent, the stationary phase chromatographic absorbent has a density gradient of anionic or cationic groups whereby the density of the anionic or cationic groups increases substantially linearly or nonlinearly, or decreases substantially linearly or nonlinearly from the entry point of the eluent stream to the exit point of the eluent stream;
thereby providing the stationary phase chromatographic absorbent with a time and position varying composition whereby the retention of adsorbed molecules varies with position and time on the stationary phase.

14. A chromatographic media comprising a stationary phase chromatographic adsorbent, wherein:
the stationary phase chromatographic absorbent comprises a mixture of particles of n types where n≧2 and each of the n types of particle has a different composition of hydrophobic groups covalently bound to its surface, thereby providing each of the n types of particles with a different hydrophobicity; and
the surface of the stationary phase chromatographic absorbent further comprises ion exchange particles distinct from the n types of particles, and the ion exchange particles are capable of absorbing molecules by electrostatic charge interactions;
wherein the stationary phase chromatographic adsorbent is disposed in the chromatographic media so that substantially perpendicular to the direction of flow of an eluent and substantially radially symmetric to the center of flow of the eluent, the proportion of each of the n types of particle varies so as to create a gradient in overall hydrophobicity such that the hydrophobicity of the stationary phase chromatographic absorbent decreases linearly or nonlinearly, from the center of flow of the eluent stream to the periphery of the eluent stream, and the proportion of the ion exchange particles relative to the n types of particles increases substantially linearly or nonlinearly from the center of flow of the eluent stream to the periphery of the eluent stream, and substantially radially symmetric to the center of flow of the eluent.

15. The chromatographic media of claims 1-4, 7-11, 13, and 14, wherein the hydrophobic groups covalently bound to the surface of the stationary phase chromatographic absorbent comprises one or more selected from the group consisting of: aliphatic chains containing m carbons where 2≦m≦18, aryls containing 1 or more phenyl chains, a group prepared by the surface reaction of divinyl benzene, cyano, polyamide, poly(propyl aspartamide), poly(ethyl aspartamide), poly(methyl aspartamide), hydroxyl terminated polyethers, ethers containing m carbons, and combinations thereof.

16. The chromatographic media of claims 2, 4, 5, 9, 11, and 12, wherein the covalently immobilized anionic or cationic hydrophilic groups comprise one or more selected from the group consisting of sulfonic, carboxylic, primary amino, secondary amino, tertiary amino, and combinations thereof.

17. The chromatographic media of claims 1-14, wherein the stationary phase chromatographic absorbent adsorbents are confined in or bonded to a support selected from the group consisting of glass sheets, plastic sheets and paper sheets.

18. A chromatographic method comprising:
adding a sample comprising a mixture of different types of molecules to a chromatographic media of claims 1-14;
eluting a sample from the chromatographic media with an eluent, whereby at least one of the different types of molecules of the sample is obtained in higher purity than its purity in the sample;
wherein the temperature of the stationary phase chromatographic absorbent is maintained by an external heating or cooling system at a temperature T_{c} such that 0° C.≦T_{c}≦110° C.

19. The method of claim 18, wherein the temperature of the stationary phase chromatographic absorbent can be a constant temperature, or a temperature gradient, wherein the temperature gradient includes a longitudinal temperature gradient, a radial temperature gradient, and/or a temporal gradient, and the temperature ranges from about 0° C. to about 100° C.
